(19) United States
(12) Patent Application Publication
(10) Pub. No.: US 2025/0044158 A1
(43) Pub. Date: Feb. 6, 2025

(54) SPATIAL-MODE-RESOLVING BOLOMETER

(71) Applicant: RTX BBN Technologies, Inc., Cambridge, MA (US)

(72) Inventors: Kin Chung Fong, Concord, MA (US); Caleb Berne Fried, Newton, MA (US)

(21) Appl. No.: 18/791,603

(22) Filed: Aug. 1, 2024

Related U.S. Application Data
(60) Provisional application No. 63/530,667, filed on Aug. 3, 2023.

(51) Int. Cl. G01J 5/24; G01J 5/20

(52) U.S. Cl. CPC G01J 5/24; G01J 2005/208

(57) ABSTRACT

An infrared red (IR) detector includes a substrate configured to absorb IR energy, and at least one electrode pair comprising a superconducting material. The at least one electrode pair is arranged at an outer edge of the substrate. IR energy absorbed by the substrate diffuses toward the outer edge while dissipating as heat from a surface of the substrate, and the at least one electrode pair conducts the heat at the outer edge to facilitate measurement of the heat.

### CROSS-REFERENCE TO RELATED APPLICATIONS

This application claims the benefit of U.S. Provisional Application No. 63/530,667 filed Aug. 3, 2023, the disclosure of which is incorporated herein by reference in its entirety.

### BACKGROUND

Infrared (IR) detection is a critical technology that involves sensing and measuring infrared radiation, a type of electromagnetic radiation with wavelengths longer than visible light but shorter than microwaves. This radiation is typically emitted by objects as heat, and IR detection technologies convert this radiation into electrical signals that can be measured and analyzed. There are two primary types of IR detectors: photon detectors and thermal detectors. Photon detectors detect measure incident photons making them suitable for use in high-sensitivity and fast-response applications, including secure quantum networks and optical quantum computing. Thermal detectors measure the change in temperature caused by absorbing IR radiation, while photon detectors directly detect individual infrared photons and convert their energy into electrical signals. Bolometers are a type of thermal detector that measures energy of incident radiation.

### SUMMARY

According to a non-limiting embodiment, an infrared red (IR) detector includes a substrate configured to absorb IR energy, and at least one electrode pair comprising a superconducting material. The at least one electrode pair is arranged at an outer edge of the substrate. IR energy absorbed by the substrate diffuses toward the outer edge while dissipating as heat from a surface of the substrate, and the at least one electrode pair measures the heat at the outer edge.

In any one or combination of the embodiments disclosed herein, the substrate comprises graphene.

In any one or combination of the embodiments disclosed herein, the superconducting material comprises one or a combination of titanium (Ti), aluminum (Al), niobium nitride (NbN), molybdenum-rhenium alloy (MoRe).

In any one or combination of the embodiments disclosed herein, the at least one electrode pair and the substrate are coupled together so as to establish a graphene Josephson junction.

In any one or combination of the embodiments disclosed herein, the at least one electrode pair includes a first leg coupled to a first surface of the substrate and a second leg connected to an opposing second surface of the substrate.

In any one or combination of the embodiments disclosed herein, the at least one electrode pair includes a plurality of electrodes disposed uniformly about the outer edge of the substrate.

In any one or combination of the embodiments disclosed herein, the IR energy absorbed by the substrate has a wavelength ranging from at least about 750 nanometers (nm) to at least 300,000 nm.

According to another non-limiting embodiment, a spatial-mode-resolving bolometer comprises at least one infrared (IR) detector configured to absorb IR energy and to conduct heat produced in response to absorbing the IR energy, and a readout sensor circuit connected to the at least one IR detector. The readout sensor circuit is configured to convert the heat into an electrical signal.

In any one or combination of the embodiments disclosed herein, a bus line in signal communication with the readout sensor circuit; and

In any one or combination of the embodiments disclosed herein, a controller is in signal communication with the bus line to receive the electrical signal to determine a spatial mode of the IR energy based on the electrical signal.

In any one or combination of the embodiments disclosed herein, the at least one IR detector comprises a substrate configured to absorb the IR energy to conduct the heat, and at least one electrode pair comprising a superconducting material. The at least one electrode pair is arranged at an outer edge of the substrate. The IR energy absorbed by the substrate diffuses toward the outer edge, and the at least one electrode conducts the heat at the outer edge to facilitate measurement of the heat.

In any one or combination of the embodiments disclosed herein, the substrate comprises graphene.

In any one or combination of the embodiments disclosed herein, the superconducting material comprises one or a combination of titanium (Ti), aluminum (Al), niobium nitride (NbN), molybdenum-rhenium alloy (MoRe).

In any one or combination of the embodiments disclosed herein, the at least one electrode pair and the substrate are coupled together so as to establish a graphene Josephson junction.

In any one or combination of the embodiments disclosed herein, the at least one electrode pair includes a first leg coupled to a first surface of the substrate and a second leg connected to an opposing second surface of the substrate.

In any one or combination of the embodiments disclosed herein, the at least one electrode pair includes a plurality of electrodes disposed uniformly about the outer edge of the substrate.

In any one or combination of the embodiments disclosed herein, the readout sensor circuit comprises a first resonator electrically connected to the first leg of the electrode, and a second resonator electrically connected between the second leg of the electrode and the bus line.

In any one or combination of the embodiments disclosed herein, the IR energy is a single photon.

According to yet another non-limiting embodiment, a method of resolving a spatial-mode of a photon is provided. The method comprises absorbing IR energy using a substrate such that the IR energy dissipates as heat while diffusing toward an outer edge of the substrate. The method further comprises conducting the heat present at the outer edge using at least one electrode pair, and converting via a readout sensor circuit connected to the at least electrode the heat into an electrical signal. The method further comprises resolving, via a controller in signal communication with the readout sensor circuit, the spatial mode of the IR energy based on the electrical signal.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts.

FIG. 1 illustrates various spatial-modes (LP modes) of a photon.

FIG. 2 illustrates a concept of superimposing different spatial-modes (LP modes).

FIG. 3 depicts an IR detector according to a non-limiting embodiment of the present disclosure.

FIG. 4 illustrates the diffusion and dissipation of heat via a graphene IR detector according to a non-limiting embodiment of the present disclosure.

FIG. 5 is a circuit diagram of a spatial-mode-resolving bolometer according to a non-limiting embodiment of the present disclosure.

FIG. 6 is a flow diagram illustrating a method of resolving a spatial-mode of a photon according to a non-limiting embodiment of the present disclosure.

### DETAILED DESCRIPTION

In optical quantum computing, spatial modes, and their subsets referred to as linearly polarized (LP) modes, can represent qubits or higher-dimensional quantum states. Spatial modes describe the pattern of the EM field in the transverse plane, i.e., perpendicular to the direction of the photon propagation. LP modes represent an approximation of the actual modes in a guided medium (e.g., optical fiber).

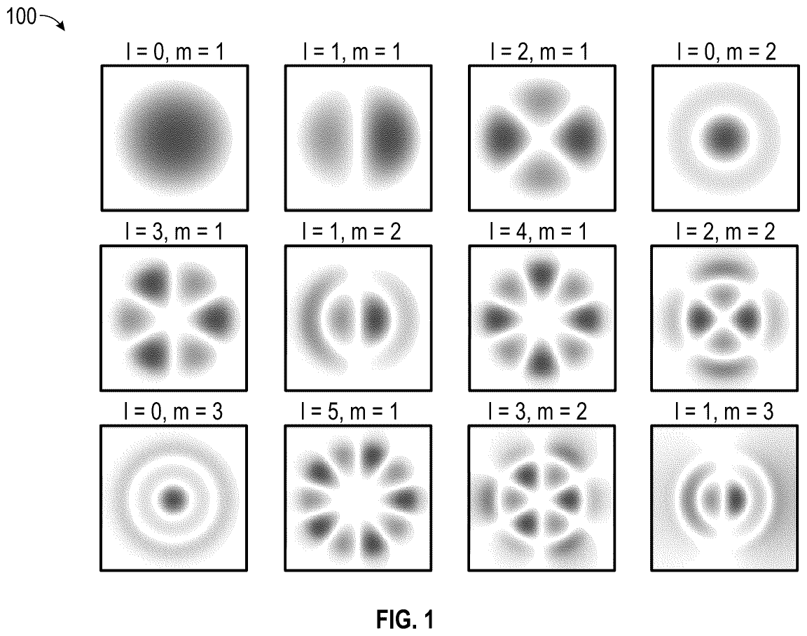

FIG. 1 illustrates various LP modes (LPₗₘ) of a photon 100. Each LP mode is defined by its azimuthal mode number (“1”) and its radial mode number (“m”). The azimuthal mode number (“1”) describes the number of intensity maxima (i.e., the lobes or petals) around the circumference of the photon). The radial mode number (“m”) indicates the number of intensity maxima (i.e., bright spots) in the radial direction (i.e., from the center outward) of the photon 100.

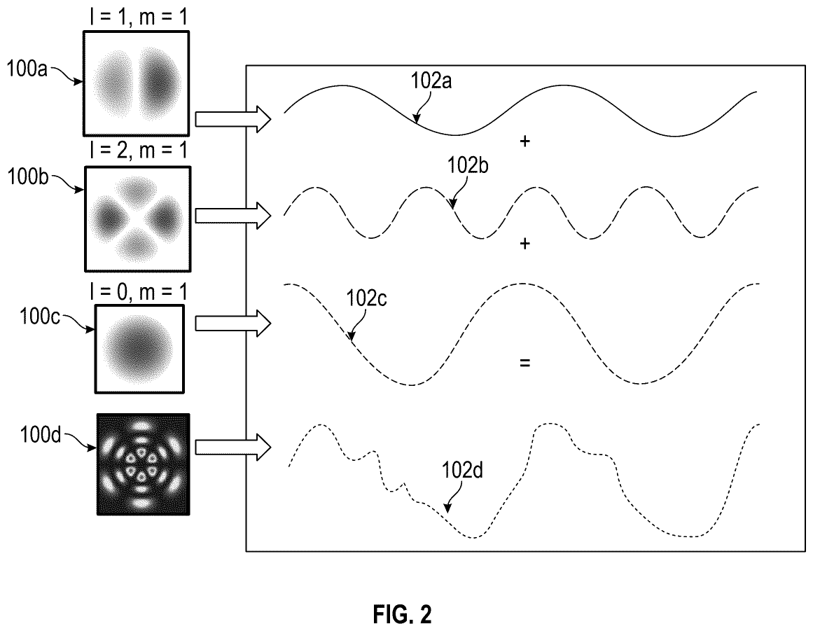

As shown in FIG. 2, different photon LP modes 100a-100c can be represented by a respective wavelength 102a-102c (e.g., respective Fourier transform signals). These spatial mode are the basis function of the quantum states of a photon and are analogous to the Fourier components of a function. The LP modes 100a-100c can be combined (e.g., modulated, superimposed or multiplexed), which generates a photon with a combined or superimposed LP mode 100d and a corresponding combined or superimposed wavelength 102d. Combining or superimposing different LP modes allows a single photon to be “coded” at a source and then subsequently decomposed or de-coded at a destination such that each of the individual wavelengths and corresponding LP modes can be identified. Although three LP modes 100a-100c and respective wavelength 102a-102c are shown, it should be appreciated that more or less LP modes 100a-100c and respective wavelength 102a-102c can be used to generate a corresponding combined or superimposed wavelength 102d without departing from the scope of the present disclosure. In one or more embodiments, quantum information can be encoded as the superposition of the spatial modes of a photon, with or without the combination of other manifold, e.g. the polarization mode.

Detectors with high spatial resolution have been developed, which implement quantum gates and circuits for performing complex quantum algorithms, and facilitating error correction schemes. For example, photon detectors integrated into photonic circuits enable the construction of scalable quantum information processing systems by providing on-chip mode detection capabilities. Despite their advancements, current state-of-the-art photon detectors face several challenges. Detection efficiency remains a significant issue, as many detectors exhibit less than perfect efficiency, leading to mis-identification of photon spatial-modes, information loss, and reduced system performance. Additionally, dark counts and noise from thermal fluctuations or environmental factors can introduce errors when attempting to identify the spatial-modes of a photon, thereby compromising the accuracy and security of quantum protocols. High timing jitter, which affects the temporal resolution of detections, also poses synchronization challenges that impact the coherence and performance of quantum systems.

Moreover, performing photon number resolution to distinguish the exact number of photons in a pulse is a crucial capability for certain quantum computing algorithms and protocols. Current photon detectors often struggle with this process, thereby affecting the precision of quantum information processing. Speed and bandwidth constraints further limit the detectors' ability to handle high-speed quantum networks and fast quantum gates.

Using current state-of-the-art bolometers in an attempt to perform spatial-mode-resolving electromagnetic (EM) detection also presents several challenges. While bolometers are highly sensitive to weak EM radiation, they typically have slow response time, low dynamic range, and are susceptible to noise making them impractical for spatial-mode-resolving detection.

Various embodiments described herein solve the short-comings discussed above by providing a spatial-mode-resolving bolometer that implements a graphene IR detector capable of operating across a wide EM spectrum ranging from near IR (e.g., wavelength ranges from 0.76 μm to 1 μm) to far IR (e.g., wavelength ranges from 15 μm micrometers to 1 mm). The spatial-mode-resolving bolometer according to embodiments of the present disclosure is capable of detecting a single impinging photon and identifying its spatial mode or linearly polarized mode (LPₗₘ). For example, the graphene IR detector absorbs the energy of the photon and converts the energy into heat. The graphene IR detector then then diffuses and dissipates the heat, both of which can be measured and correlated with one or more spatial-modes or LP modes of the impinging photon.

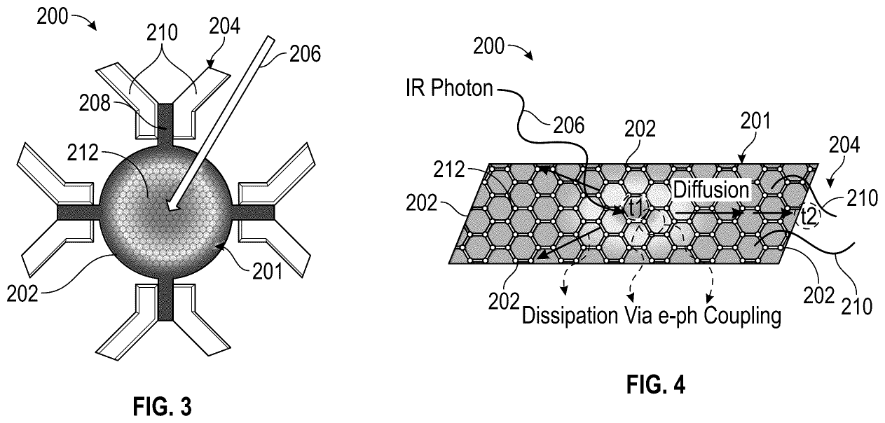

With reference now to FIG. 3, an IR detector 200 is illustrated according to a non-limiting embodiment of the present disclosure. The IR detector 200 can serve as an “IR pixel” capable of detecting IR energy 206 (e.g., a photon). The IR detector 200 is formed from a substrate 201 comprising an IR-detecting material capable of absorbing and detecting IR energy 206 having a wavelength ranging from about 750 nanometers (e.g., NIR wavelengths) to about 300,000 nm (FIR wavelengths), and beyond. According to a non-limiting embodiment, the IR detecting material comprises a semi-metal material such as, for example, graphene. The IR detector 200 can have various shapes or profiles such as, for example, circular, square, rectangular, etc.

The IR detector 200 includes one or more electrodes 204 that are arranged at the outer edge 202 of the substrate 201. The electrodes are formed from various superconducting materials including, but not limited to, titanium (Ti), aluminum (Al), niobium nitride (NbN), molybdenum-rhenium alloy (MoRe), and a combination thereof. According to a non-limiting embodiment, the electrodes 204 are coupled to respective terminals 208 that extend from the outer edge 202 of the substrate 201 to establish a graphene Josephson junction. In one or more non-limiting embodiments, the IR detector 200 includes a plurality of electrodes disposed uniformly about the outer edge 202 of the substrate. Although four electrodes 204 are shown, it should be appreciated that more or less electrodes 204 can be implemented to increase the number of temperature sensors at different locations of the IR detector 200. For example, the combination of the temperature rise spatially and temporally can improve measurement of spatial mode of the incident photon. In at least one embodiment, each electrode 204 includes an opposing pair of legs 210. A first leg 210 is disposed against a first surface of the terminal 208 while the opposing second leg 210 is disposed against the opposing surface of the terminal 208. According to a non-limiting embodiment, each electrode 204 (e.g., the first and second legs 210) is formed from a superconducting material.

The IR detector 200 operates by receiving IR energy 206 (e.g., a photon) that impinges on the surface 212 of the substrate 201. This IR energy 206 will diffuse toward the detector outer edge 202 while dissipating heat from the detector surface 212 over a time period (t). Once reaching the outer edge 202, the remaining heat will be conducted through the electrodes 204 to facilitate measurement of the heat. This heat can then be measured and compared to pre-determined heat diffusion and/or heat dissipation profiles associated with a given photon LP mode to resolve and identify the spatial mode(s) of the IR energy 206 (e.g., photon) impinging upon the detector surface 212.

FIG. 4, for example, illustrates the diffusion and dissipation of heat via the IR detector 200. IR energy 216 in the form of a photon having an initial amount of energy impinges the detector surface 212 at a first time period (t1). The energy of the photon is then dissipated and diffused in the form of heat. The diffused heat reaches travels from the center of the detector surface 212 toward the outer edge 202. At a subsequent second time (t2) the heat is conducted through the electrode 204 to facilitate measurement of the heat. Accordingly, the duration at which the heat diffuses along with the amount of heat loss dissipated during that time can resolve or identify the spatial mode(s) of photon 206 that impinged the detector surface 212. In other words, the temperature rise at the outer edge 202 and the amount of time during which the temperature at the outer edge 202 rises can be used to resolve and identify the spatial mode(s) of the photon that impinged the detector surface 212.

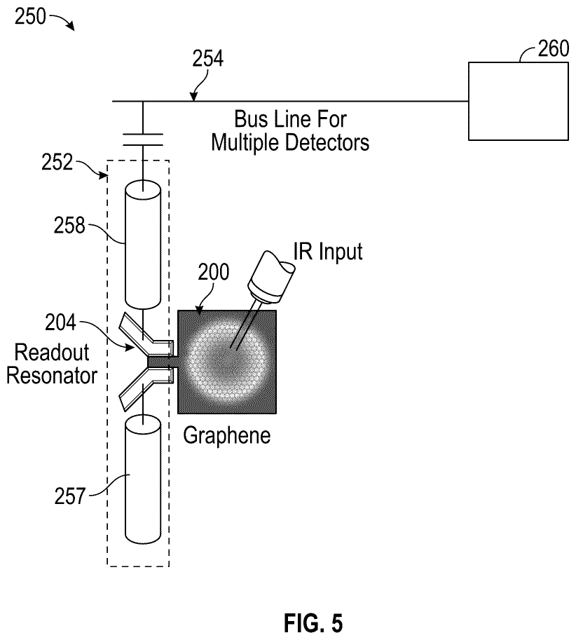

Turning now to FIG. 5, a circuit diagram of the spatial-mode-resolving bolometer 250 is illustrated according to a non-limiting embodiment of the present disclosure. The spatial-mode-resolving bolometer 250 includes the IR detector 200, a readout sensor circuit 252, and a bus line 254 in signal communication with the readout sensor circuit 252.

The readout sensor circuit 252 is configured to resonate at a frequency (i.e., a resonant frequency) in response to heat, and to generate an electrical signal indicative of the resonant frequency. The readout sensor circuit 252 includes a first resonator 257 and a second resonator 258. The first resonator 257 is electrically connected to the first leg 210 of the electrode 204. The second resonator 258 is electrically connected between the opposing second leg 210 of the electrode 204 and the bus line 254. According to a non-limiting embodiment, the first resonator 257 and the second resonator 258 can be constructed as an inductor-capacitor element, which resonates at a given frequency in response to an amount of heat conducted through the inductor. Accordingly, the first and second resonators 257 and 258 can be connected together to establish a dipole that produces a resonant frequency based on the heat conducted by the corresponding electrode 204 to facilitate measurement of the heat.

As described herein, a photon 206 impinging on the IR detector 204 produces heat that dissipates from the detector surface 212 and diffuses toward the detector out edge 202. The heat measured using the electrode 204 by modulating the frequency of the second resonator 258, thereby inducing an electrical signal that is delivered to the bus line 254. The electrical signal on the bus line 254 can then be delivered to a controller 260, where it is measured to resolve and identify the spatial mode(s) of the photon 206 impinging on the detector surface 212. As descried herein, the electrical signal output by the readout sensor circuit 252 is indicative of the resonant frequency (e.g., produced by the first and second resonators 257 and 258). Accordingly, the controller 260 can analyze the electrical signal to determine the resonant frequency produced by the first and second resonators 257 and 258, and in turn determine the spatial mode of the photon 206 impinging on the detector surface 212.

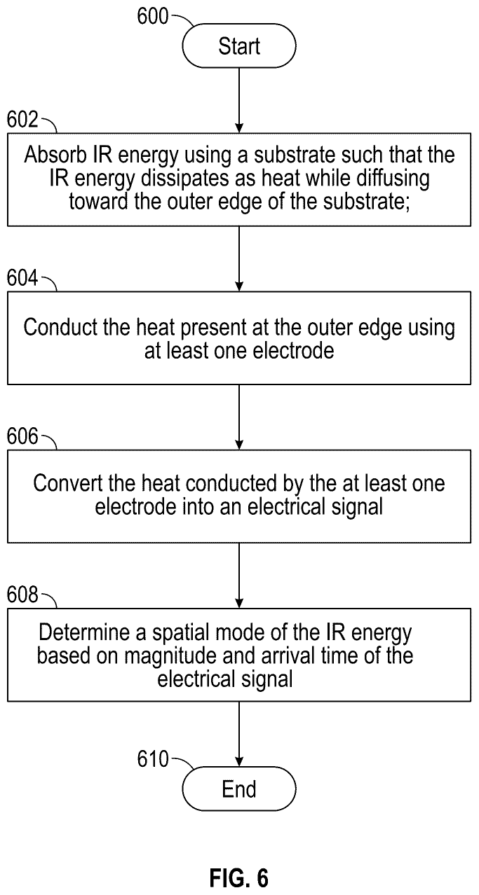

Turning now to FIG. 6, a method of resolving a spatial-mode of a photon is illustrated according to a non-limiting embodiment of the present disclosure. The method begins at operation 600, and at operation 602 IR energy (e.g., a photon) is absorbed using a substrate. According to a non-limiting embodiment, the substrate comprises graphene. In response to being absorbed, the IR energy dissipates as heat while diffusing toward the outer edge of the substrate. At operation 604, the heat present at the outer edge of the substrate is conducted using at least one pair of electrodes to facilitate measurement of the heat. According to a non-limiting embodiment, the electrode pair comprises a superconducting material to establish a graphene Josephson junction. At operation 606, the heat received at the at least one electrode pair is converted into an electrical signal. According to a non-limiting embodiment, a readout sensor circuit is connected to the at least one pair of electrodes and converts the heat into the electrical signal. At operation 608, the spatial mode of the IR energy (e.g., photon) is determined based on the strength and arrival time of the electrical signal. According to a non-limiting embodiment, a controller is in signal communication with the readout sensor circuit to receive the electrical signal and resolve the spatial-mode of the photon based on the electrical signal, and the method ends at operation 610. It should be understood that all embodiments which have been described may be combined in all possible combinations with each other, except to the extent that such combinations have been explicitly excluded.

Finally, nothing in this Specification or the Appendix shall be construed as an admission of any sort. Even if a technique, method, apparatus, or other concept is specifically labeled as “prior art,” “conventional,” “background,” “existing,” etc., Applicant make no admission that such technique, method, apparatus, or other concept is actually prior art under 35 U.S.C. § 102 or 103, such determination being a legal determination that depends upon many factors, not all of which are known to Applicant at this time.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An infrared red (IR) detector comprising:
a substrate configured to absorb IR energy;
at least one pair of electrodes comprising a superconducting material, and at least one pair of electrodes arranged at an outer edge of the substrate,
wherein IR energy absorbed by the substrate diffuses toward the outer edge while dissipating as heat from a surface of the substrate, and
wherein the at least one electrode conducts the heat at the outer edge.

2. The IR detector of claim 1, wherein the substrate comprises graphene.

3. The IR detector of claim 2, wherein the superconducting material comprises one, or a combination of, titanium (Ti), aluminum (Al), niobium nitride (NbN), molybdenum-rhenium alloy (MoRe).

4. The IR detector of claim 3, wherein the at least one electrode pair and the substrate are coupled together so as to establish a graphene Josephson junction.

5. The IR detector of claim 4, wherein the at least one electrode pair includes a first leg coupled to a first surface of the substrate and a second leg connected to an opposing second surface of the substrate.

6. The IR detector of claim 4, wherein the at least one electrode pair includes a plurality of electrodes disposed uniformly about the outer edge of the substrate.

7. The IR detector of claim 4, wherein the IR energy absorbed by the substrate has a wavelength ranging from at least about 750 nanometers (nm) to at least 300,000 nm.

8. A spatial-mode-resolving bolometer comprising:
at least one infrared (IR) detector configured to absorb IR energy and to conduct heat produced in response to absorbing the IR energy; and
a readout sensor circuit connected to the at least one IR detector, the readout sensor circuit configured to convert the heat into an electrical signal.

9. The spatial-mode-resolving bolometer of claim 8, further comprising:
a bus line in signal communication with the readout sensor circuit; and
a controller in signal communication with the bus line to receive the electrical signal, the controller configured to determine a spatial mode of the IR energy based on the electrical signal.

10. The spatial-mode-resolving bolometer of claim 9, wherein the at least one IR detector comprises:
a substrate configured to absorb the IR energy to conduct the heat; and
at least one electrode pair comprising a superconducting material, the at least one electrode pair arranged at an outer edge of the substrate,
wherein IR energy absorbed by the substrate diffuses toward the outer edge, and wherein the at least one electrode pair measures the heat at the outer edge.

11. The spatial-mode-resolving bolometer of claim 10, wherein the substrate comprises graphene.

12. The spatial-mode-resolving bolometer of claim 11, wherein the superconducting material comprises one, or a combination of, titanium (Ti), aluminum (Al), niobium nitride (NbN), molybdenum-rhenium alloy (MoRe).

13. The spatial-mode-resolving bolometer of claim 12, wherein the at least one electrode pair and the substrate are coupled together so as to establish a graphene Josephson junction.

14. The spatial-mode-resolving bolometer of claim 13, wherein the at least one electrode pair includes a first leg coupled to a first surface of the substrate and a second leg connected to an opposing second surface of the substrate.

15. The spatial-mode-resolving bolometer of claim 13, wherein the at least one electrode pair includes a plurality of electrodes disposed uniformly about the outer edge of the substrate.

16. The spatial-mode-resolving bolometer of claim 14, wherein the readout sensor circuit comprises:
a first resonator electrically connected to the first leg of the electrode; and
a second resonator electrically connected between the second leg of the electrode and the bus line.

17. The spatial-mode-resolving bolometer of claim 8, wherein the IR energy is a single photon.

18. A method of resolving a spatial-mode of a photon, the method comprising:
receiving the photon impinging upon a substrate;
absorbing IR energy of the photon using the substrate, the IR energy dissipating as heat while diffusing toward an outer edge of the substrate;
conducting the heat present at the outer edge using at least one electrode pair;
converting, via a readout sensor circuit connected to the at least electrode, the heat into an electrical signal; and
resolving, via a controller in signal communication with the readout sensor circuit, the spatial mode of the IR energy based on the electrical signal.

19. The method of claim 18, wherein the substrate comprises graphene.

20. The method of claim 19 wherein the superconducting material comprises one, or a combination of, titanium (Ti), aluminum (Al), niobium nitride (NbN), molybdenum-rhenium alloy (MoRe).
